(19) United States
(12) Patent Application Publication
(10) Pub. No.: US 2006/0176819 A1
(43) Pub. Date: Aug. 10, 2006

(54) Method for operating a network node of a communication network and network node of a communication network

(75) Inventors: Joachim Charzinski, Munchen (DE); Anton Schmit, Vaterstetten (DE); Richard Vierthaler, Munchen (DE); Martin Winter, Rosenheim (DE)

Correspondence Address: SIEMENS CORPROATION;INTELLECTUAL PROPERTY DEPARTMENT, 170 WOOD AVENUE, SOUTH, ISELIN, NJ, 08830, US

(73) Assignee: SIEMENS AKTIENGESSELLSCHAFT

(21) Appl. No.: 11/347,546

(22) Filed: Feb. 3, 2006

(30) Foreign Application Priority Data
Feb. 4, 2005 (DE) 102005005278.9

(51) Int. Cl. H04J 3/14; H04L 12/28

(52) U.S. Cl. 370/238; 370/254

(57) ABSTRACT

A method for operating a network node of a communication network is provided, the network node having a routing method. Before any configuration of the network node by a control device, a minimum waiting time of the network node for the calculation of routing paths is increased after a configuration change. Configuration data is then read into the network node, whereafter said minimum waiting time is reset to a lower value.

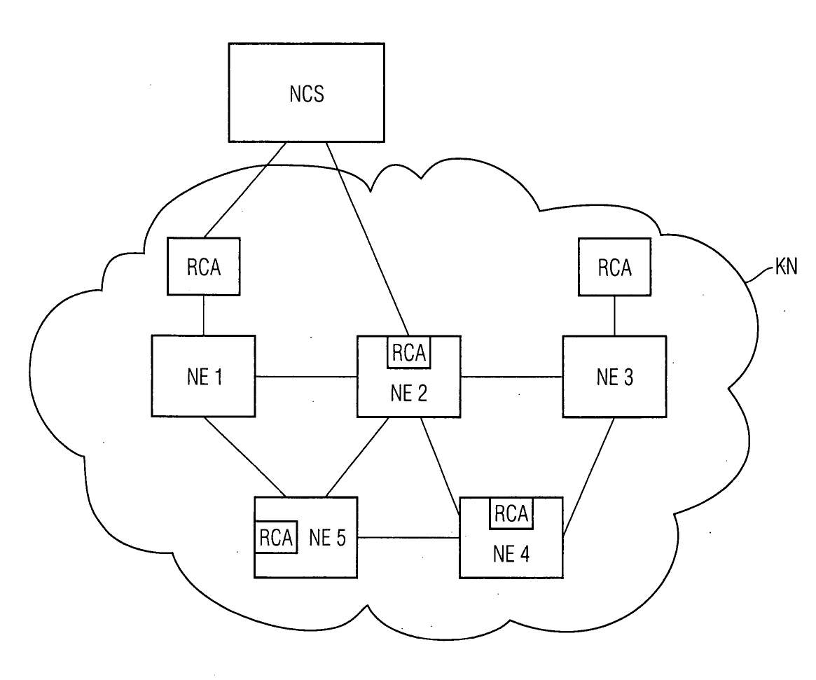

### CROSS REFERENCE TO RELATED APPLICATIONS

This application claims priority of German application No. 102005005278.9 DE filed Feb. 4, 2005 which is incorporated by reference herein in its entirety.

### FIELD OF INVENTION

The invention relates to a method for operating a network node of a communication network and to a network node of a communication network.

### BACKGROUND OF INVENTION

Communication networks, such as—for example—the Internet, consist of network nodes that are interconnected via connection paths or connections such as electrical cables or optical fibers. Examples of such network nodes include routers, switches, network elements, gateways, bridges or other communication devices. In communication networks, data is transmitted in data packets, by means of data packets, using protocols such as routing protocols. An example of such a protocol is the Internet protocol, abbreviated to IP protocol. Appropriate routing algorithms—such as Open Shortest Past First, abbreviated to OSPF—are used in the network node depending on the protocol used. Communication networks are often named after the protocol used, for example networks that use the IP protocol are called IP networks.

The routing protocols that run in the network node exchange so-called protocol data units, abbreviated to PDUs, with one another. In this way routing protocol information, such as topological information, is mutually exchanged. Routing algorithms or routing processes of the routing protocol are used in each case to identify data routes or paths from one network node to another (destination) network node. The length of the paths to a destination or destination network node is determined by the sum of so-called connection, link or interface cost metrics of the network node. The cost metrics determine the respective costs in a network node for an outgoing connection path of the network node. The adjacent network node of the shortest route or path to a destination network node is entered as the so-called next hop in a routing table of the network node for the corresponding destination network node. If several shortest paths of equal lengths are detected, then the so-called equal cost multi path protocol—abbreviated to ECMP—may be used to determine that data packets are transmitted alternately via both/all paths of equal lengths, i.e. all next hop network nodes are recorded in the routing table.

In order to divert traffic, i.e. data packets, from a source to a destination network node, from connections or routes with high traffic load to less heavily used connections, it is often proposed that the connection, link or interface cost metrics of the network nodes in the network should not be equally selected or distributed in the network, but should be set according to the result of a multidimensional optimization. The cost metrics are set in practice by configuration commands with which the individual network nodes are configured or with which new configuration data, such as cost metrics, is read or loaded into the network nodes. Since every change to a configuration, such as a new cost metric, may generate on a network node a so-called update report of the routing protocol, said report being sent to every network node in the communication network, and since every network node or router restarts its routing algorithm for route calculation after receiving such reports, routing instabilities can occur in the routing in the communication network during the amendment of configuration data such as (cost) metrics. This may at times cause data or data packets to be lost. If the network nodes are configured by a central configuring component, such as an administration system/management system or network control server, abbreviated to NCS, then the instability phase must be kept as short as possible. For this reason configuration changes are often carried out at night, so that as little data traffic as possible is affected by the changes. It is also why, until now, most networks have been operated with homogenous metrics. This means that the costs of a path to a destination network node correspond to the number of network nodes to the destination network node. Any dynamic adjustment of the configuration or of the metrics of the network elements in a network—several times a day, for example—therefore cannot easily be done without data loss.

### SUMMARY OF INVENTION

An object of this invention is to improve the operation of network nodes in a communication network.

This object is achieved by a method and a network node incorporating the features independent claims.

Before any configuration of a network node, a minimum waiting time of the network node, or of all or a part of the network nodes of the communication network for calculation of the routing paths, is increased after a configuration change, or the waiting time for the recalculation of routing paths is increased after receipt of configuration reports, such as so-called link status (LSP) reports, of other network nodes in the communication network, or the minimum waiting time for the transmission of separate configuration reports to other network nodes is increased. This means that the processing of configuration changes that have been read in or received, or the submission of configuration changes, is suppressed. New configuration data is then read or loaded into the network node or nodes. After this configuration data has been successfully read into the network elements to be configured, this minimum waiting time or blocking time for the processing of configuration data that has been read in or received from other network nodes, or for the recalculation of routing paths, is reset to a lower value or to the original value. The advantage of the invention consists in that configuration changes, such as the reading in of new metrics, may be effected without the multiple recalculation of the routing paths in each network node. Any multiple rerouting is suppressed by a self-modifying routing table. Data packet losses are thus avoided and the stability of the communication is increased. This invention may be used to particular advantage for changing cost metrics of the network nodes. Before new cost metrics are read in, said minimum waiting times are increased—preferably in all network nodes of the communication network. New cost metrics are then read into the network elements to be configured and the minimum waiting times are then reset to the original value.

Advantageous embodiments of the invention are specified in the dependent claims.

In one advantageous embodiment of the invention, the minimum waiting time is reset to a lower value only after a message from an administration system, such as a management system or network control server, or at a specific point in time. This has the particular advantage that the conversion to the minimum waiting time, and therefore the start of the calculations of new routing paths or routing tables takes place more or less simultaneously in all network elements of the communication network, the phase of adjustment to the new configuration data is reduced, and thus inconsistencies in the network are reduced or avoided.

### BRIEF DESCRIPTION OF THE DRAWING

An exemplary embodiment of the invention is shown in the diagram and is explained below. In this diagram,

FIGURE shows a communication network.

### DETAILED DESCRIPTION OF INVENTION

The FIGURE shows a communication network KN, for example an IP network, consisting of a plurality of network nodes NE1 to NE5, which are linked to one another by means of connections. Each network node has a connection to an administration/management system or network control server NCS, which functions as a configuring component for the network elements. The network nodes have an internal or external control component, such as a router control agent RCA. The control component RCA is connected to the network control server NCS. It may be positioned upstream or downstream of the network node, or integrated into it. The control component RCA may also be implemented as a software program in the network node. Alternatively, a control component may also be provided for a plurality of network nodes.

If the network control server NCS wishes to reconfigure the network nodes NE1 to NE5 of its communication network, in its capacity as a control device it increases—by means of a command to preferably all network nodes—the value of the minimum waiting time of the network nodes for the calculation of routing paths following a configuration change, or the minimum waiting time for the recalculation of routing paths following receipt of configuration messages, or the minimum waiting time for the transmission of separate configuration messages to other network nodes. For example, by increasing the so-called SPF hold times in an IP network. It then loads the configuration changes into the network elements to be configured. After this step is completed it advantageously resets the minimum waiting time or the SPF hold timer in the network elements to the original value or to a value prescribed for operation of the network

The function of increasing the minimum waiting time may also be implemented in a control component RCA which is positioned upstream of or integrated into the network node, and which—after receiving configuration data—increases the minimum waiting time, loads or reads in the configuration data, and then resets the waiting time to the operating value. The function may also be implemented in the network node, for example by means of software.

As an alternative to changing the minimum waiting time of the said functions, a blocking of the processing of configuration or topological information in the network node may also be triggered. The essential aspect is that data received from other network elements is not evaluated during the reconfiguration, or that data packets with configuration data of the network element to be configured are not submitted to the other network elements for the time being, or that the calculation of a new routing table is suppressed during the reconfiguration, until the network elements to be configured have new data. Only than is the exchange of configuration data in the network and the recalculation of the routing paths or routing table to be triggered in the network elements.

To ensure that the recalculation is as synchronous as possible, the calculation may be effected by a command from the control device, or by a transmitted time or time stamp at which the conversion to the new data is carried out by reduction of the minimum waiting time. The messages with the configuration changes may also be provided with a time stamp such that the configuration changes only become effective after or at a fixed point in time.

The minimum waiting time also includes a minimum waiting time between two consecutive calculations of the routing paths or of the routing table in the network node.

By temporarily increasing the minimum waiting times or the timer values, such as the SPF hold timer, fewer link status messages are generated, sent and evaluated and therefore new routing tables are calculated less frequently in the network nodes. Since each change to the routing may result in short-term breaks in the packet transmission, with packets being lost or going round in a loop in the network, the inventive measures reduce the adverse effects of the traffic flowing in the network when new configurations are read into the network nodes, such as the reading in of new cost metrics in routers. This facilitates increased network stability during the reading in of new cost metrics, enabling network functionality to become quickly reestablished. In this way, cost metrics may be optimized or retrospectively optimized during normal network operation.

1.-7. (canceled)

8. A method for operating a network node of a communication network, the network node having a routing method, comprising:
increasing a minimum waiting time of the network node for the calculation of routing paths after a configuration change;
reading the configuration change into the network node after increasing the minimum time; and
resetting the minimum waiting time to a lower value after reading the configuration change into the network node,
wherein the increasing, reading and resetting steps are handled prior to a configuration of the network node by a control device.

9. The method according to claim 8, wherein after the configuration change is read into the network node, resetting the minimum waiting time to a lower value is delayed until after a message from an administration system or after specific point in time.

10. The method according to claim 8,
wherein the communication network is executed as an Internet Protocol (IP) network,
wherein the value of the SPF hold timer is increased before the configuration of the network node, and
wherein the SPF hold timer is reset to a lower value after the configuration change is read.

11. The method according to claim 9,
wherein the communication network is executed as an Internet Protocol (IP) network,
wherein the value of the SPF hold timer is increased before the configuration of the network node, and
wherein the SPF hold timer is reset to a lower value after the configuration change is read.

12. A method for operating a plurality of network nodes of a communication network by one or more control devices, the network node having a routing method, comprising:
increasing a minimum waiting time of at least a part of the network nodes for the calculation of routing paths after a configuration change;
reading the configuration change into the network nodes after increasing the minimum time; and
resetting the minimum waiting time to a lower value in at least part of the network nodes after reading the configuration change into the network nodes,
wherein the increasing, reading and resetting steps are handled prior to a configuration of the network nodes by a control device or control devices.

13. The method according to claim 12, wherein after the configuration change is read into the network nodes, resetting the minimum waiting time to a lower value is delayed until after a message from an administration system or after specific point in time.

14. The method according to claim 12,
wherein the communication network is executed as an Internet Protocol (IP) network,
wherein the value of the SPF hold timer is increased before the configuration of the network node, and
wherein the SPF hold timer is reset to a lower value after the configuration change is read.

15. The method according to claim 13,
wherein the communication network is executed as an Internet Protocol (IP) network,
wherein the value of the SPF hold timer is increased before the configuration of the network node, and
wherein the SPF hold timer is reset to a lower value after the configuration change is read.

16. A network node of a communication network, comprising:
a configuration data providing information for changes to the node; and
a minimum wait time for caluculating routing paths following a configuration change is increased;
wherein after the configuration data is loaded into the network node, the minimum waiting time is set to a lower value.

17. The node according to claim 16, wherein after the configuration change is read into the network nodes, resetting the minimum waiting time to a lower value is delayed until after a message from an administration system or after specific point in time.
